(19) United States
(12) Patent Application Publication
(10) Pub. No.: US 2015/0146115 A1
(43) Pub. Date: May 28, 2015

(54) DISPALY DEVICE AND LIQUID CRYSTAL PRISM CELL PANEL

(71) Applicant: SHENZHEN CHINA STAR OPTOELECTRONICS TECHNOLOGY CO. LTD., Shenzhen, Guangdong (CN)

(72) Inventors: Qiaosheng Liao, Shenzhen (CN); Chihming Yang, Shenzhen (CN)

(21) Appl. No.: 14/129,999

(22) PCT Filed: Dec. 5, 2013
(86) PCT No.: PCT/CN2013/088589

§ 371 Date: Dec. 30, 2013

(30) Foreign Application Priority Data
Nov. 28, 2013 (CN) 201310626920.X

(51) Int. Cl. G02B 27/22

(52) U.S. Cl. CPC G02B 27/225
USPC 349/15

(57) ABSTRACT

A display device with a liquid crystal prim cell is disclosed. The liquid crystal prism cell panel has first and second substrates, liquid crystal layer and control circuit; the liquid crystal layer is disposed between a first electrode layer and a second electrode layer; the control circuit is configured to control a voltage difference between the first and second electrode layers; the first electrode layer has at least two strip-shaped electrodes, the a light-shielding components are disposed on a position of the second substrate corresponding to the strip-shaped electrodes. The liquid crystal device can enhance the display quality of a three-dimensional image.

### FIELD OF THE INVENTION

The present invention relates to a display device field, and in more particular to a display device and a liquid crystal prism cell panel.

### BACKGROUND OF THE INVENTION

A technical scheme of a conventional auto-stereoscopic three-dimensional image display device to show a three-dimensional image is generally:

Stacking a prism plate on the display panel, the prism plate having a number of cylindrical prisms so that the left-eye image and right-eye image of the display panel can be respectively provided for a user's left-eye and right-eye through the prisms of the prism plate.

Through practice, the inventor found at least one following problem existing in the prior art:

In the above technical scheme, the conventional display device effect a poorer three-dimensional image display quality. Thus, it is necessary to provide a new technical scheme to solve the above problem.

### SUMMARY OF THE INVENTION

A objective of the present invention is to provide a display device and a liquid crystal prism cell panel which can enhance a display performance of a three-dimensional image.

To achieve the above objective, a technical scheme introduced by a preferred embodiment of the present invention is as follows. A display device comprises a display panel including a first light-emitting surface; and a liquid crystal prism cell panel comprising a light-incident surface and a second light-emitting surface, wherein the light-incident surface is disposed on the first light-emitting surface of the display panel, and the liquid crystal prism cell panel further comprises: a first substrate where a first electrode layer is disposed; a second substrate where a second electrode layer is disposed; a liquid crystal layer disposed between the first electrode layer and the second electrode layer; and a control circuit for controlling a voltage difference between the first electrode layer and the second electrode layer; wherein the first electrode later includes at least two strip-shaped electrodes, at least two light-shielding components are disposed on a position of the second substrate corresponding to the strip-shaped electrodes; the control circuit is configured to control the liquid crystal molecules in the liquid crystal layer being arranged in parallel with each other under a manner when the display device needs to display a two-dimensional image thereon, the control circuit may further configured to control the liquid crystal molecules being arranged in a graded-index lens state under a manner when the display device needs to display a three-dimensional image thereon; at least two of the strip-shaped electrodes are arranged in parallel with each other, two adjacent electrodes of the strip-shaped electrodes are disposed on an edge of a region corresponding to at least one pixel or sub-pixel in the display panel.

In the graded-index lens state of the above display device, at least two liquid crystal molecules between the two adjacent strip-shaped electrodes are arranged in an arc state to constitute a prism, a multiplayer of which are stacked together to form a lens with a graded-index variance.

In the above display device, the light-shielding components are disposed between the second substrate and the second electrode layer.

In the above display device, the light-shielding components are arranged in the second electrode layer.

In the above display device, the liquid crystal prism cell panel further comprises: a transparent cover disposed on the second light-emitting surface, which has a surface facing to the second substrate and disposed with at least two concaves thereon, the concaves where the light-shielding components are arranged being located at a position corresponding to the position of the strip-shaped electrodes.

A display device comprises: a display panel including a first light-emitting surface and a liquid crystal prism cell panel, the liquid crystal prism cell panel comprises a light-incident surface and a second light-emitting surface, wherein the light-incident surface is disposed on the first light-emitting surface of the display panel, the liquid crystal prism cell panel further comprises: a first substrate where a first electrode layer is disposed; a second substrate where a second electrode is disposed; a liquid crystal layer disposed between the first electrode layer and the second electrode layer; and a control circuit for controlling a voltage difference between the first electrode layer and the second electrode layer; wherein the first electrode layer includes at least two strip-shaped electrodes, at least two light-shielding components are disposed on a position of the second substrate corresponding to the strip-shaped electrodes.

In the above display device, the control circuit is configured to control the liquid crystal molecules in the liquid crystal layer being arranged in parallel with each other under a manner when the display device needs to display a two-dimensional image thereon. The control circuit may be further configured to control the liquid crystal molecules being arranged in a graded-index lens state under a manner when the display device needs to display a three-dimensional image thereon.

In the graded-index lens state of the above display device, at least two liquid crystal molecules between the two adjacent strip-shaped electrodes are arranged in an arc state to constitute a prism, a multilayer of which are stacked together to form a lens with a graded-index variance.

In the above display device, the light-shielding components are disposed between the second substrate and the second electrode layer.

In the above display device, the light-shielding components are arranged in the second electrode layer.

In the above display device, the liquid crystal prism cell panel further comprises: a transparent cover disposed on the second light-emitting surface, which has a surface facing to the second substrate and disposed with at least two concaves thereon, the concaves where the light-shielding components are arranged being located at a position corresponding to the position of the strip-shaped electrodes.

In the above display device, there are at least two strip-shaped electrodes arranged in parallel with each other. Two adjacent electrodes of the strip-shaped electrodes are disposed on an edge of a region corresponding to at least one pixel or sub-pixel in the display panel.

A liquid crystal prism cell panel comprises: a light-incident surface and second light-emitting surface, wherein the light-incident surface of the liquid crystal prism cell panel is disposed on the first light-emitting surface of the display panel, which is combined with the liquid crystal prism cell panel. The liquid crystal prism cell panel further comprises: a first substrate where a first electrode layer is disposed; a second substrate where a second electrode is disposed; a liquid crystal layer disposed between the first electrode layer and the second electrode layer; and a control circuit for controlling a voltage difference between the first electrode layer and the second electrode layer; wherein the first electrode layer includes at least two strip-shaped electrodes, at least two light-shielding components are disposed on a position of the second substrate corresponding to the strip-shaped electrodes.

In the above liquid crystal prism cell panel, the control circuit is configured to control the liquid crystal molecules in the liquid crystal layer being arranged in parallel with each other under a manner when the display device needs to display a two-dimensional image thereon. The control circuit may be further configured to control the liquid crystal molecules being arranged in a graded-index lens state under a manner when the display device needs to display a three-dimensional image thereon.

In the graded-index lens state of the above liquid crystal prism cell panel, at least two liquid crystal molecules between the two adjacent strip-shaped electrodes are arranged in an arc state to constitute a prism, a multiplayer of which are stacked together to form a lens with a graded-index variance.

In the above liquid crystal prism cell panel, the light-shielding components are disposed between the second substrate and the second electrode layer.

In the above liquid crystal prism panel, the light-shielding components are arranged in the second electrode layer.

The above liquid crystal prism cell panel further comprises: a transparent cover disposed on the second light-emitting surface, which has a surface facing to the second substrate and disposed with at least two concaves thereon, the concaves where the light-shielding components are arranged being located at a position corresponding to the position of the strip-shaped electrodes. The light-shielding components are arranged in the concaves.

In the above liquid crystal prism cell panel, there are at least two strip-shaped electrodes which are arranged in parallel with each other, and two adjacent strip-shaped electrodes which are disposed on an edge of a region corresponding to at least one pixel or sub-pixel in the display panel.

Compared to the prior art, the display device and the liquid crystal prism cell panel of the present invention can enhance a display performance of a three-dimensional image.

For a better understanding of the aforementioned content of the present invention, preferable embodiments are illustrated in accordance with the attached figures for further explanation.

### BRIEF DESCRIPTION OF THE DRAWINGS

FIG. 1 is a schematically structural diagram illustrating a display device of the present invention.

FIG. 2 is a schematic diagram illustrating a 2-D image of a display device in accordance with the present invention.

FIG. 3 is a schematic diagram illustrating a 3-D image of a display device in accordance with the present invention.

FIG. 4 is a schematic diagram of the first embodiment under a 3-D image state of a liquid crystal prism cell panel in accordance with the present invention.

FIG. 5 is a schematic diagram of the first embodiment under a 2-D image state of a liquid crystal prism cell panel.

FIG. 6 is a schematic diagram of the second embodiment under a 3-D image state of a liquid crystal prism cell panel in accordance with the present invention.

FIG. 7 is a schematic diagram of the third embodiment under a 3-D image state of a liquid crystal prism cell panel in accordance with the present invention.

### DETAILED DESCRIPTION OF THE PREFERRED EMBODIMENTS

The following descriptions for the respective embodiments are specific embodiments capable of being implemented for illustrations of the present invention, with reference to the appended figures.

The term “embodiment” in the specification is used as typical example, demonstration or illustration. It is intended to provide a concept by specific ways. In the appended claims and throughout the specification, the terms “a” and “an” are used as the plain-English equivalents of the respective terms “one” or “more”, unless specified otherwise or clear from the context to be directed to a singular form.

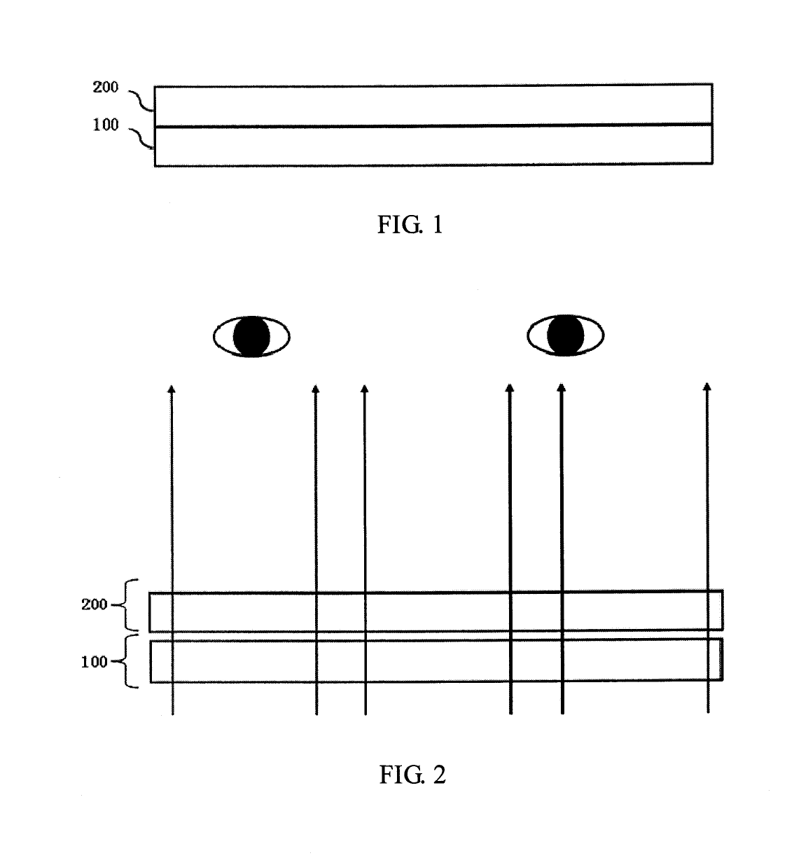

Please refers to FIG. 1 which is a schematically structural diagram illustrating a display device of the present invention. The display device of the present invention comprises a display panel 100 and a liquid crystal prism cell panel 200, wherein the liquid crystal prism cell panel 200 is stacked above the display panel 100. The display panel can be LCD (Liquid Crystal Display) or OLED (Organic Light-emitting Diode) panels. The display device of the present invention can display two-dimensional images, as well as three-dimensional images. Also, it can be further switched from a two-dimensional image display state to a three-dimensional image display state.

Please refers to FIG. 2 which is a schematic diagram illustrating a two-dimensional image of a display device in accordance with the present invention. When the display device of the present invention is in a two-dimensional image display state, the display panel 100 is in the corresponding working status for proving a two-dimensional image, which means that the display panel 100 is configured here to produce (display) a two-dimensional image. At the same time, the liquid crystal prism cell panel 200 switches to a flat lens state when the display device is in the two-dimensional display state. Herein mentioned the flat lens is a lens without change of a light propagating direction.

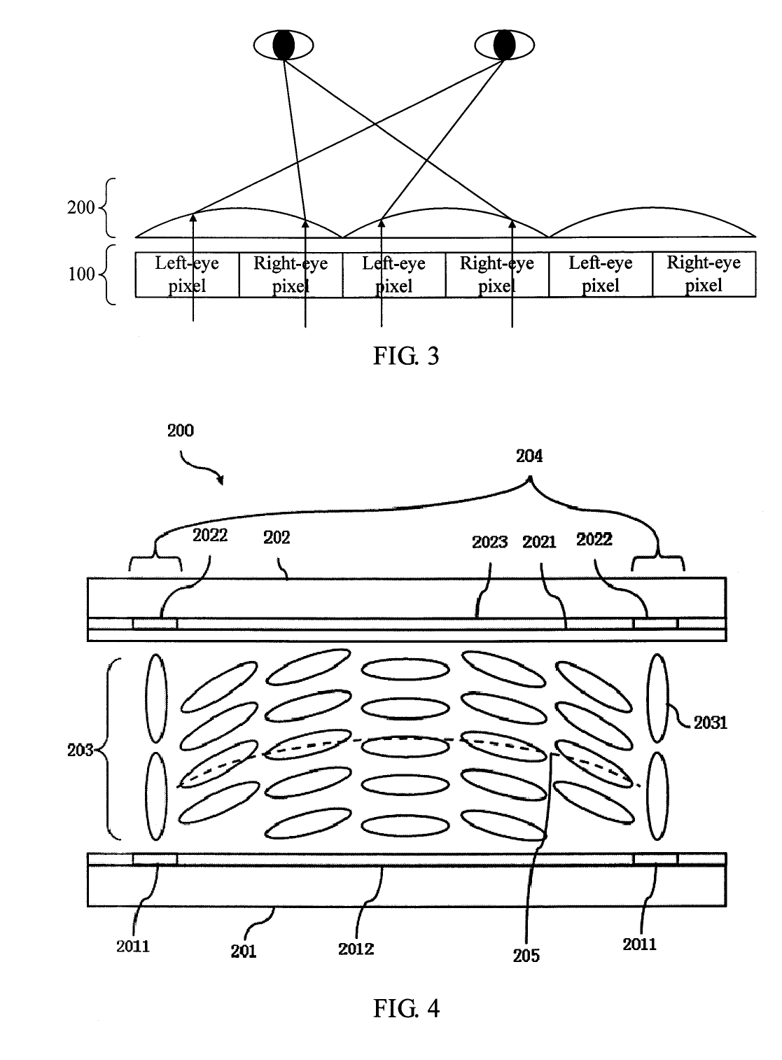

Please refers to FIG. 3 which is a schematic diagram illustrating a three-dimensional image of a display device in accordance with the present invention. When the display device of the present invention is in a three-dimensional image display state, the display panel 100 is in the corresponding working status for proving a three-dimensional image, which means that the display panel 100 is configured herein to produce (display) a three-dimensional image. At the same time, the liquid crystal prism cell panel 200 switches to a liquid crystal graded-index lens (GRIN) state when the display device is in the three-dimensional display state, where the liquid crystal graded-index lens is a prism array which comprises at least two prisms. The prism is employed to refract the light corresponding to the left-eye pixel to the user's left eye, as well as refract the light corresponding to the right-eye pixel to the user's right eye.

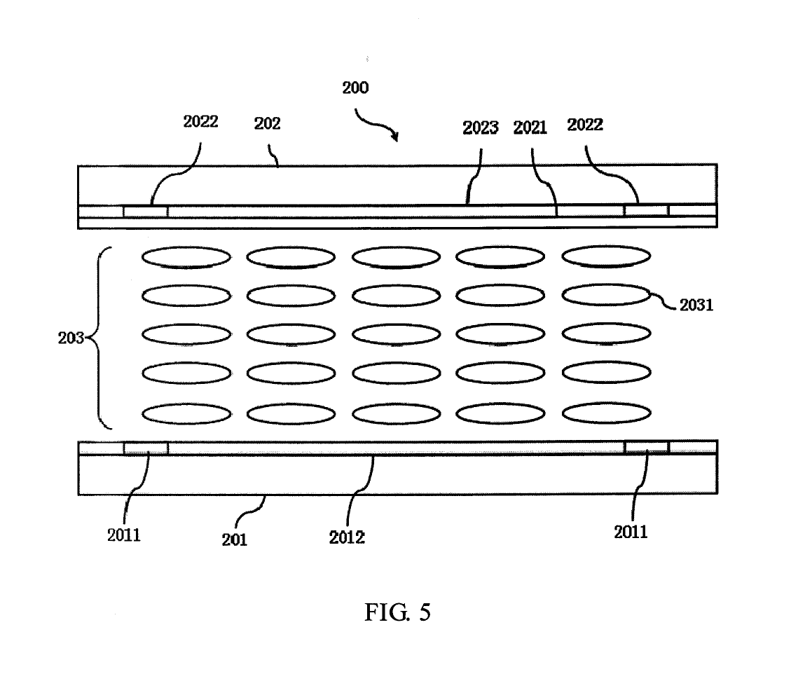

Please refers to FIG. 4 and FIG. 5. FIG. 4 shows a schematic diagram of a first embodiment under a three-dimensional image display state of a liquid crystal prism cell panel in accordance with the present invention, while FIG. 5 shows a schematic diagram illustrating the liquid crystal prism cell panel 200 of FIG. 4 under a two-dimensional image display state.

A display device of the present embodiment comprises a display panel 100 and a liquid crystal prism cell panel 200. The display panel 100 includes a first light-emitting surface. The liquid crystal prism cell panel 200 comprises a light-incident surface and a second light-emitting surface, wherein the light-incident surface of the liquid crystal prism cell panel 200 is disposed on the first light-emitting surface of the display panel 100. The liquid crystal prism cell panel 200 and the display panel 100 are combined together.

The liquid crystal prism cell panel 200 comprises a first substrate 201, a second substrate 201, a liquid crystal layer 203, and a control circuit wherein the first substrate 201 is disposed with a first electrode layer 2011 thereon, and the second substrate 202 is disposed with a second electrode layer 2021 thereon. In between the first electrode layer 2011 and the second electrode layer 2021, the liquid crystal layer 203 is disposed and the control circuit is configured to control a voltage difference, wherein the first electrode later 2011 includes at least two strip-shaped electrodes 2011, and at least two light-shielding components 2022 are disposed on a position of the second substrate 202 corresponding to the strip-shaped electrodes 2011. The at least two strip-shaped electrodes 2011 are arranged in parallel with each other and with the data lines of the display panel 100, while the strip-shaped electrodes are vertical to the scan lines/gate lines of the display panel 100. The two adjacent strip-shaped electrodes 2011 are disposed on an edge of a region corresponding to either at least one pixel or at least one sub-pixel in the display panel 100.

In the display device of the present invention, the control circuit is configured to control the liquid crystal molecules in the liquid crystal layer being arranged in parallel with each other under a manner when the display device needs to display a two-dimensional image thereon, as show in FIG. 5. At that time the control circuit is configured to control the voltage difference in a zero volts between the first electrode layer 2011 and the second electrode layer 2021. The control circuit can be further configured to control the liquid crystal molecules being arranged in a graded-index lens state under a manner when the display device needs to display a three-dimensional image thereon, as show in FIG. 4. In the graded-index lens state, at least two liquid crystal molecules 2031 between the two adjacent strip-shaped electrodes 2011 are arranged in an arc state 205 to constitute a prism, and therefore refract the Light in a determined direction. In the present embodiment, the liquid crystal molecules 2031 with the arc state 205 are layered and stacked to be a multilayer forming a gradient index (gradient change) lens (prism) which is a lens with a graded-index variance.

In the present embodiment, the light propagating direction of the image produced by the display panel 100 can change in gradient through the liquid crystal graded-index lens. Thus, the light may propagate (irradiate, refract) in different directions, which is conducive to the rendering of a three-dimensional display (auto-stereoscopic display, naked-eye stereoscopic display), and enhances the display performance of a three-dimensional image.

A region 204 shown in FIG. 4 is a liquid crystal dumping region. The liquid crystal dumping region is located in a position corresponding to the strip-shaped electrodes 2011. In this region, the liquid crystal molecules 2031 appear in a dumping status. Here, the light irradiating to the dumping region will propagate along in an unexpected direction. In the present embodiment, due to the fact that the light-shielding components 2022 are disposed on a position of the second substrate 202 corresponding to the strip-shaped electrodes 2011, the light-shielding components 2022 may block divergent light. Particularly, the light-shielding component 2022 may be configured to absorb uncontrolled light in order to further reduce crosstalk in a three-dimensional display, and to enhance the display performance of a three-dimensional image.

In the display device of the present embodiment, the light-shielding components 2022 are disposed between the second substrate 202 and the second electrode layer 2021. The light-shielding components are coated with an insulating layer 2023. The second electrode layer 2022 is disposed on the insulating layer 2023. In the present embodiment, the material of the light-shielding components 2022 may use the same material as the black matrix layer. The light-shielding components 2022 may be formed by the following method of: coating (arranging) the light-shielding components 2022 on a position of the second substrate 202 corresponding to the strip-shaped electrodes 2011, and then coating the insulating layer 2023 and the second electrode layer 2021 on the second substrate 202 with the light-shielding components 2022, respectively.

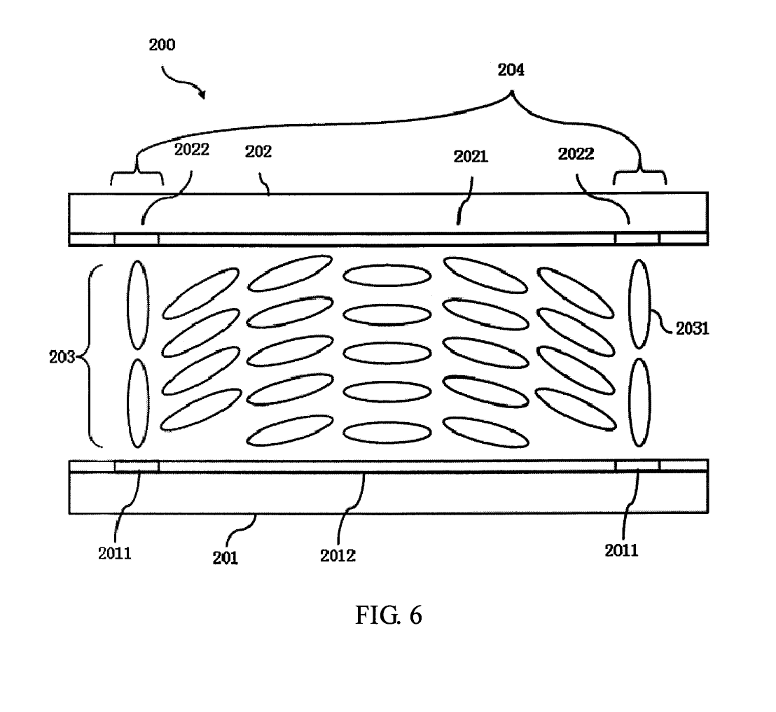

Please refers to FIG. 6 which is a schematic diagram of the second embodiment under a three-dimensional image state of a liquid crystal prism cell panel in accordance with the present invention. Similarly to the first embodiment, this embodiment has the difference where:

In the second embodiment, the light-shielding components 2022 are arranged in the second electrode layer 2021. The light-shielding components 2022 may be formed by the following method of: disposing the second electrode layer 2021 on the second substrate 202, and etching concaves on a position of the second electrode layer 2021 corresponding to the strip-shaped electrodes 2011, then coating (arranging) the light-shielding components 2022 in the concaves.

The light-shielding components 2022 may further be formed by the following method: coating (disposing) the light-shielding components 2022 on a position of the second substrate 202 corresponding to the strip-shaped electrodes 2011, and then disposing the second electrode layer 2021 on the second substrate 202 at the portion without disposing the light-shielding components 2022.

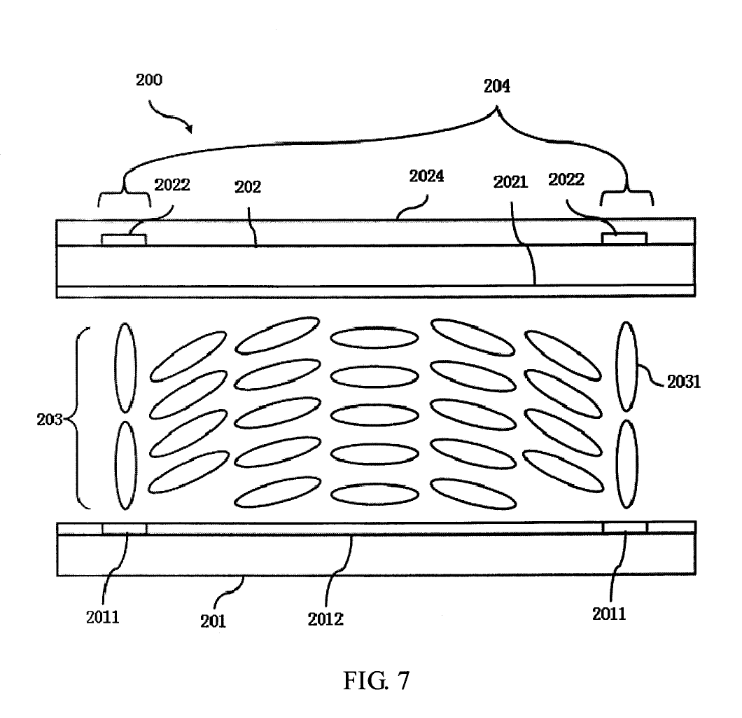

Please refers to FIG. 7 which is a schematic diagram of the third embodiment under a three-dimensional image state of a liquid crystal prism cell panel in accordance with the present invention. Similarly to the above mentioned first embodiment and second embodiment, this embodiment has the difference where:

In the third embodiment, the liquid crystal prism cell panel 200 further comprises a transparent cover 2024 disposed on the second light-emitting surface, which has a surface facing to the second substrate 202 and disposed with at least two concaves thereon, the concaves where the light-shielding components 2022 are arranged being located at a position corresponding to the position of the strip-shaped electrodes 2011.

The light-shielding components 2022 may be formed by the following method of: arranging at least two concaves on a portion of the transparent cover 2024 corresponding to the strip-shaped electrodes 2011, and coating (arranging) the light-shielding components 2022 in the concave, then stacking the transparent cover 2024 on the second light-emitting surface of the second substrate 202.

The light-shielding components 2022 may further be formed by the following method of coating (disposing) the light shielding component 2022 on the second light-emitting surface of a position of the second substrate 202 corresponding to the strip-shaped electrodes 2011, and then combining the transparent cover 2024 having concaves with the second substrate 202, wherein the concaves are located at a position of the transparent cover 2024 corresponds to the strip-shaped electrodes 2011.

Various features have been grouped together in one or more examples with the purpose of streamlining the disclosure. Many other examples will be apparent to one skilled in the art upon reviewing the above specification. All alternatives, modifications and equivalents are intended to be covered by the present invention. Also, in the appended claims and throughout the specification, the terms “including” and “having” are used as the plain-English equivalents of the term “comprising” and the like.

Accordingly, the foregoing descriptions of a preferred embodiments of the invention have been presented for purposes of illustration and description. They are not intended to be to be exhaustive or to limit the invention to the precise forms disclosed. Obvious modifications or variations are possible in light of the above teachings with regards to the specific embodiments. The embodiments were chosen and described in order to best illustrate the principles of the invention and its practical applications, thereby enabling one of ordinary skill in the art to best utilize the invention in various embodiments and with various modifications as are suited to the particular use contemplated. It is intended that the scope of the invention be defined by the claims which are appended hereto.

What is claimed is:

1. A display device comprising:
a display panel, including a first light-emitting surface; and
a liquid crystal prism cell panel, comprising a light-incident surface and a second light-emitting surface, wherein the light-incident surface of the liquid crystal prism cell panel is disposed on the first light-emitting surface of the display panel, the liquid crystal prism cell panel further comprising:
a first substrate where a first electrode layer is disposed;
a second substrate where a second electrode layer is disposed;
a liquid crystal layer disposed between the first electrode layer and the second electrode layer; and
a control circuit for controlling a voltage difference between the first electrode layer and the second electrode layer, wherein
the first electrode layer includes at least two strip-shaped electrodes, and at least two light-shielding components are disposed on a position of the second substrate corresponding to the strip-shaped electrodes;
the control circuit controls liquid crystal molecules in the liquid crystal layer being arranged in parallel with each other under a manner when the display device needs to display a two-dimensional image thereon, and the control circuit further controls the liquid crystal molecules in the liquid crystal layer being arranged in a graded-index lens state under a manner when the display device needs to display a three-dimensional image thereon; and
at least two of the strip-shaped electrodes are arranged in parallel with each other, two adjacent electrodes of the strip-shaped electrodes are disposed on an edge of a region corresponding to at least one pixel or sub-pixel in the display panel.

2. The display device as claimed in claim 1, wherein in the graded-index lens state, at least two liquid crystal molecules between the two adjacent strip-shaped electrodes are arranged in an arc state to constitute a prism, a multilayer of which are stacked together to form a lens with a graded-index variance.

3. The display device as claimed in claim 1, wherein the light-shielding components are disposed between the second substrate and the second electrode layer.

4. The display device as claimed in claim 1, wherein the light-shielding components are arranged in the second electrode layer.

5. The display device as claimed in claim 1, wherein the liquid crystal prism cell panel further comprises:
a transparent cover disposed on the second light-emitting surface, which has a surface facing to the second substrate and disposed with at least two concaves thereon, the concaves where the light-shielding components are arranged being located at a position corresponding to the position of the strip-shaped electrodes.

6. A display device comprising:
a display panel including a first light-emitting surface; and
a liquid crystal prism cell panel comprising a light-incident surface and a second light-emitting surface, wherein the light-incident surface of the liquid crystal prism cell panel is disposed on the first light-emitting surface of the display panel, the liquid crystal prism cell panel further comprising:
a first substrate where a first electrode layer disposed;
a second substrate where a second electrode layer disposed;
a liquid crystal layer disposed between the first electrode layer and the second electrode layer; and
a control circuit, for controlling a voltage difference between the first electrode layer and the second electrode layer; wherein
the first electrode layer includes at least two strip-shaped electrodes, and at least two light-shielding components are disposed on a position of the second substrate corresponding to the strip-shaped electrodes.

7. The display device as claimed in claim 6, wherein the control circuit controls liquid crystal molecules in the liquid crystal layer being arranged in parallel with each other under a manner when the display device needs to display a two-dimensional image thereon, the control circuit further controls liquid crystal molecules in the liquid crystal layer being arranged in a graded-index lens state under a manner when the display device needs to display a three-dimensional image thereon.

8. The display device as claimed in claim 7, wherein in the graded-index lens state, at least two liquid crystal molecules between the two adjacent strip-shaped electrodes are arranged in an arc state to constitute a prism, a multilayer of which are stacked together to form a lens with a graded-index variance.

9. The display device as claimed in claim 6, wherein the light-shielding components are disposed between the second substrate and the second electrode layer.

10. The display device as claimed in claim 6, wherein the light-shielding components are arranged in the second electrode layer.

11. The display device as claimed in claim 6, wherein the liquid crystal prism cell panel further comprises:
a transparent cover disposed on the second light-emitting surface, which has a surface facing to the second substrate and disposed with at least two concaves thereon, the concaves where the light-shielding components are arranged being located at a position corresponding to the position of the strip-shaped electrodes.

12. The display device as claimed in claim 6, wherein at least two of the strip-shaped electrodes are arranged in parallel with each other, two adjacent electrodes of the strip-shaped electrodes are disposed on an edge of a region corresponding to either at least one pixel or sub-pixel in the display panel.

13. A liquid crystal prism cell panel comprising a light-incident surface and a second light-emitting surface, wherein the light-incident surface of the liquid crystal prism cell panel is disposed on the first light-emitting surface of the display panel which is combined with the liquid crystal prism cell panel, the liquid crystal prism cell panel further comprising:
a first substrate where a first electrode layer is disposed;
a second substrate where a second electrode layer is disposed;
a liquid crystal layer, the liquid crystal layer is disposed between the first electrode layer and the second electrode layer; and
a control circuit, for controlling a voltage difference between the first electrode layer and the second electrode layer; wherein the first electrode layer includes at least two strip-shaped electrodes, and at least two light-shielding components are disposed on a position of the second substrate corresponding to the strip-shaped electrodes.

14. The liquid crystal prism cell panel as claimed in claim 13, wherein the control circuit controls liquid crystal molecules in the liquid crystal layer being arranged in parallel with each other under a manner when the display device needs to display a two-dimensional image thereon, the control circuit further controls liquid crystal molecules in the liquid crystal layer being arranged in a graded-index lens state under a manner when the display device needs to display a three-dimensional image thereon.

15. The liquid crystal prism cell panel as claimed in claim 14, wherein in the graded-index lens state, at least two liquid crystal molecules between the two adjacent strip-shaped electrodes are arranged in an arc state to constitute a prism, a multilayer of which are stacked together to form a lens with a graded-index variance.

16. The liquid crystal prism cell panel as claimed in claim 13, wherein the light-shielding components are disposed between the second substrate and the second electrode layer.

17. The liquid crystal prism cell panel as claimed in claim 13, wherein the light-shielding components are arranged in the second electrode layer.

18. The liquid crystal prism cell panel as claimed in claim 13, wherein the liquid crystal prism cell panel further comprising: a transparent cover disposed on the second light-emitting surface, which has a surface facing to the second substrate and disposed with at least two concaves thereon, the concaves where the light-shielding components are arranged being located at a position corresponding to the position of the strip-shaped electrodes.

19. The liquid crystal prism cell panel as claimed in claim 13, wherein at least two strip-shaped electrodes are arranged in parallel with each other, two adjacent electrodes of the strip-shaped electrodes are disposed on an edge of a region corresponding to at least one pixel or sub-pixel in the display panel.
